(19) United States
(12) Patent Application Publication
(10) Pub. No.: US 2025/0385468 A1
(43) Pub. Date: Dec. 18, 2025

(54) ELECTRICAL CONNECTOR ASSEMBLY WITH AN IMPROVED MATING INTERFACE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: DE-JIN CHEN, Shenzhen (CN); Gao Xiang, Shenzhen (CN); Feng Pan, Austin, TX (US)

(21) Appl. No.: 18/743,438

(22) Filed: Jun. 14, 2024

(51) Int. Cl. H01R 13/629; H01R 13/6581

(52) U.S. Cl. CPC H01R 13/629; H01R 13/6581

(57) ABSTRACT

An electrical connector assembly includes a receptacle and a plug. The receptacle includes: an insulating housing having two mating slots; two rows of terminals located at opposite sides of each of the two mating slots; and a metallic shell surrounding around an outer side of the insulating housing, the insulating housing has two opposite guiding holes at opposite ends of each mating slot in the second direction, each of the guiding holes is defined by the metallic shell at an outer side perpendicular to the second direction. The plug includes: an insulating housing having a base portion; two paddle cards going across the base portion; and a pair of guiding posts extending from the base portion and located at opposite ends of each paddle card, a pair of guiding boards extend forwards from the base portion, and the guiding boards extend beyond the guiding posts in the first direction.

### BACKGROUND OF THE INVENTION

### Field of the Invention

The present invention relates to an electrical connector assembly including a plug connector and a receptacle connector with an improved mating interface.

### Description of Related Arts

China Utility Patent No. CN217903515U discloses a receptacle connector mounted on a PCB and a plug connector connecting with cables. The receptacle connector includes three signal ports loaded with signal terminals and one power port loaded with two power terminals. The power port is higher than the signal port in the mating direction, and larger than the signal portion in the transverse direction perpendicular to the side wall of the insulating housing. The power port may not meet a trend of high density, high signal speed, and small form factor in server applications.

An improved electrical connector assembly is desired.

### SUMMARY OF THE INVENTION

The instant invention is to provide an electrical connector assembly with an improved mating interface.

To achieve the above-mentioned object, a receptacle electrical connector comprises: an insulating housing having two mating slots arranged in a first direction and each of the two mating slots extending in a second direction perpendicular to the first direction; two rows of terminals located at opposite sides of each of the two mating slots; and a metallic shell surrounding around an outer sides of the insulating housing; wherein the insulating housing has two opposite guiding holes at opposite ends of each of the two mating slots in the second direction, and each of the guiding holes is defined by the metallic shell at an outer side perpendicular to the second direction.

To achieve the above-mentioned object, a plug electrical connector comprises: an insulating housing having a base portion; two paddle cards going across the base portion and arranged in a first direction, each of the two paddle cards extending in a second direction perpendicular to the firs direction; and a pair of guiding posts extending from the base portion and located at opposite ends of each of the two paddle cards; wherein a pair of guiding boards extend forwards from the base portion, and the guiding boards extend beyond the guiding posts in the first direction and are separated from two adjacent guiding posts in the second direction.

To achieve the above-mentioned object, an electrical connector assembly comprises: an insulating housing having two mating slots arranged in a first direction and each extending in a second direction perpendicular to the first direction, each of the two mating slot having a first area and a second area arranged in the second direction; two rows of signal terminals located at opposite sides of each of the first areas; and two rows of power terminals located at opposite sides of each of the second areas; wherein four flat cables are connecting with corresponding rows of signal terminals and power terminals, respectively.

### BRIEF DESCRIPTION OF DRAWINGS

FIG. 1 is a front perspective view of a receptacle connector in accordance with the present invention;

FIG. 2 is a front elevational view of the receptacle connector in FIG. 1;

FIG. 3 is an exploded perspective view of a metallic shell and an insulating housing of the receptacle connector in FIG. 1;

FIG. 4 is a perspective view of two terminal modules and cables of the receptacle connector in FIG. 1;

FIG. 5 is a perspective view of the two terminal modules in FIG. 4;

FIG. 6 is an exploded perspective view of the two terminal modules in FIG. 4;

FIG. 7 is a front perspective view of a plug connector in accordance with the present invention;

FIG. 8 is a rear perspective view of the plug connector in FIG. 7; and

FIG. 9 is a front elevational view of the plug connector in FIG. 7.

### DETAILED DESCRIPTION OF THE DRAWINGS

Reference will now be made in detail to the preferred embodiments of the present invention.

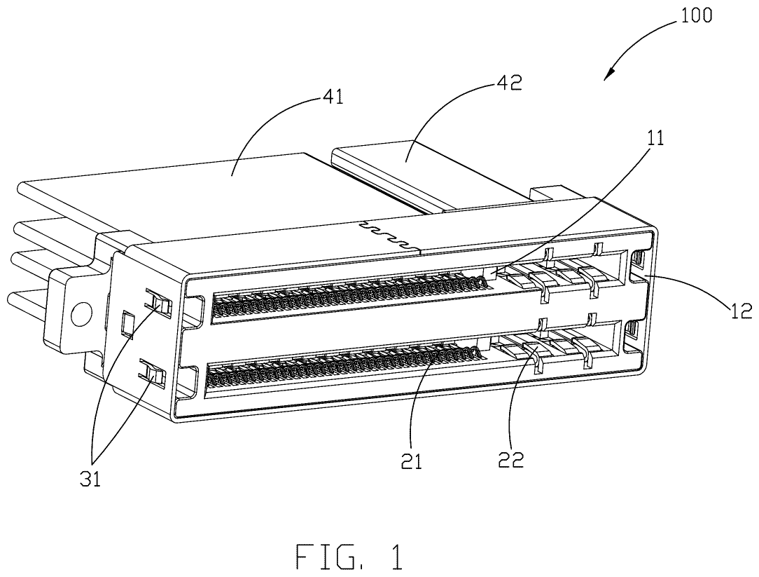

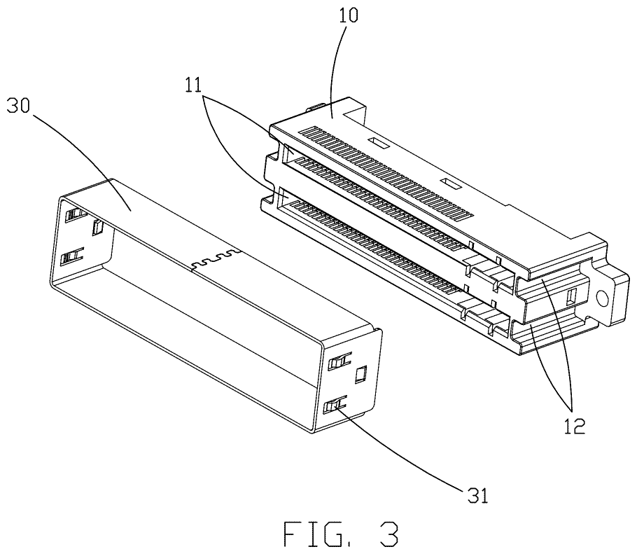

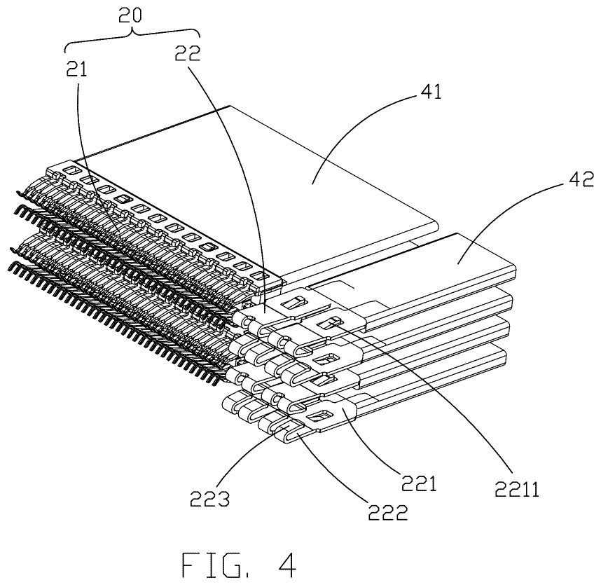

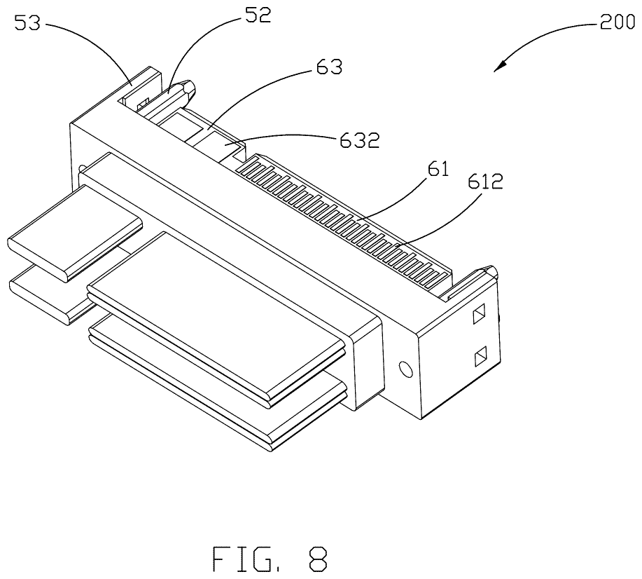

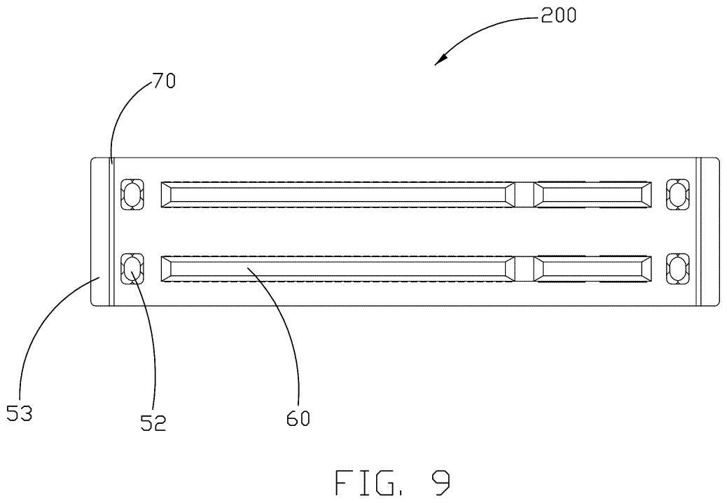

Referring to FIGS. 1-9, an electrical connector of an embodiment of this present invention includes a receptacle connector 100 and a plug connector 200, which two are adapted for mating with each other. The two electrical connectors are connecting with cables at rear ends thereof, respectively.

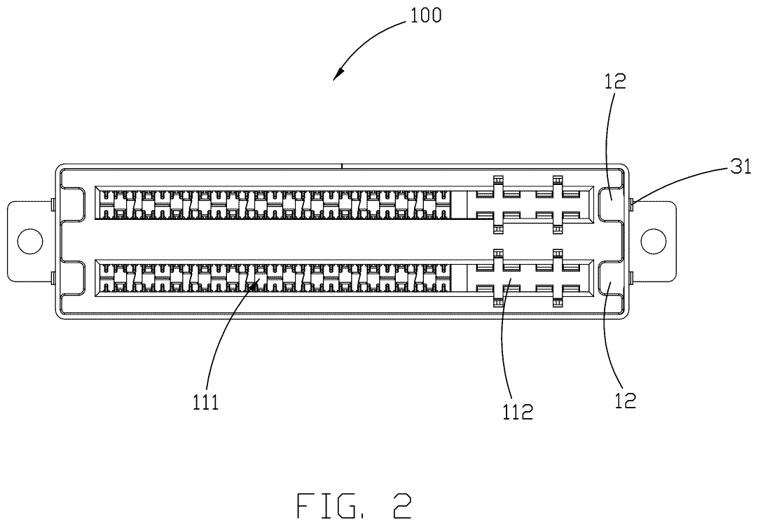

Referring to FIGS. 1-4, the receptacle connector 100 includes an insulating housing 10 having two mating slots 11 arranged in a first direction and each extending in a second direction perpendicular to the first direction, two rows of terminals 20 located at opposite sides of the mating slot 11, a metallic shell 30 surrounding around an outer sides of the insulating housing 10. The insulating housing 10 further has two opposite guiding holes 12 at opposite ends of each mating slot 11, each guiding hole 12 is defined by the metallic shell 30 at an outer side perpendicular to the second direction. Other three sides of the guiding holes are defined by the insulating housing 10. The metallic shell 30 has four spring fingers 31 extending outward in the second direction, each spring finger 31 is aligned with corresponding guiding hole 12. The guiding holes 20 are of a square shape viewed in a mating direction as shown in FIG. 2.

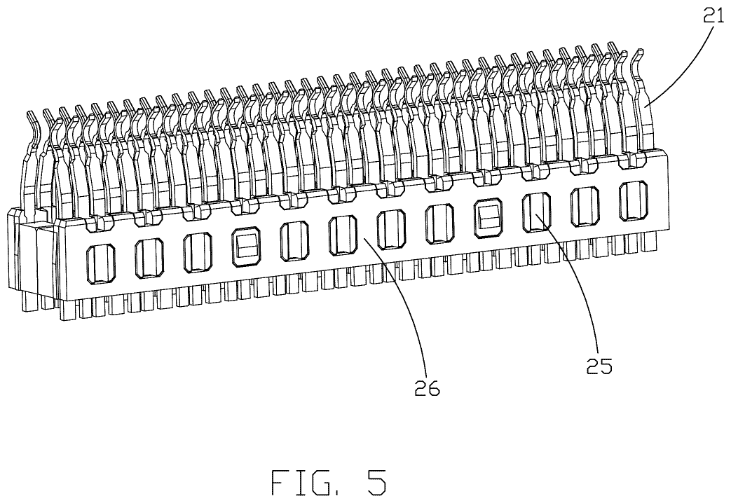

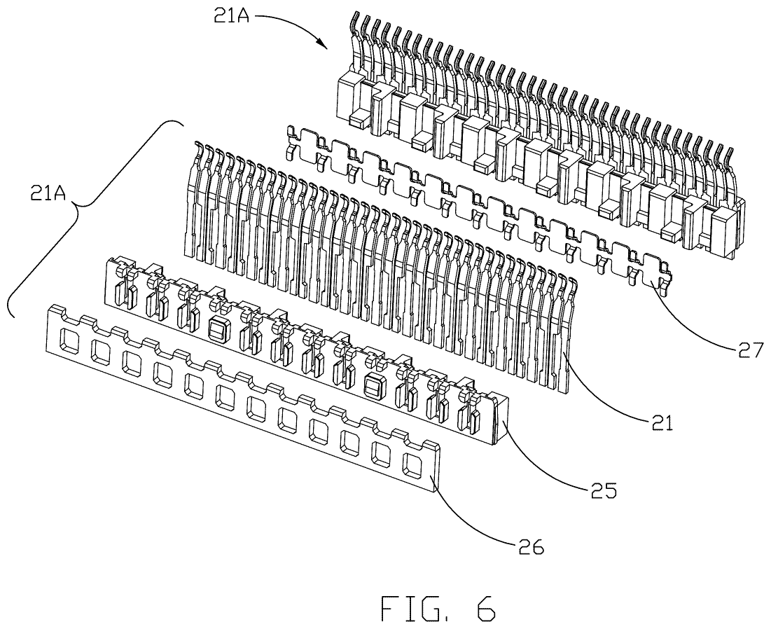

Each mating slot 11 has a first area 111 and a second area 112 arranged in the second direction. Two rows of signal terminals 21 are located at opposite sides of the signal area 111 of the mating slot 11, and two rows of power terminals 22 are located at opposite sides of the second area 112 of the mating slot 11. It is noted that the signal terminals 21 may include pairs of terminals transmitting differential signal and grounding terminals between the pairs of signal transmitting terminals for shielding and grounding function. The power terminals 22 are for transmitting larger power. The first area 111 of the mating slot is deeper than the second area 112. Each of the mating slots 11 is continuous without any partitioning wall as clearly shown in FIG. 1. In this embodiment, each row of signal terminals 21 is composed of thirty-seven terminals, each row of power terminals is composed of two terminals 22. Plural cables 41, 42 are connected with corresponding rows of signal terminals 21 and corresponding rows of power terminals 22 in a manner known to those skilled in this art. Referring to FIGS. 5-6, the row of the signal terminal 21 is embedded in an insulator 25 and a conductive plastic 26 is assembled and retained at an outer side of the insulator 25 so as to form a terminal module 21A. A metallic grounder 27 is located between the two rows of the signal terminals 21. The metallic grounder 27 and the conductive plastics 26 benefit an improved electric performance. The power terminal 22 includes a retaining portion 221 retained in the housing, an extending portion 222 and a retrace portion 223, the retrace portion 223 defines a contacting portion exposing to the mating slot 11. The retaining portion 221 has a tab 2211 for retaining the power terminal in the housing.

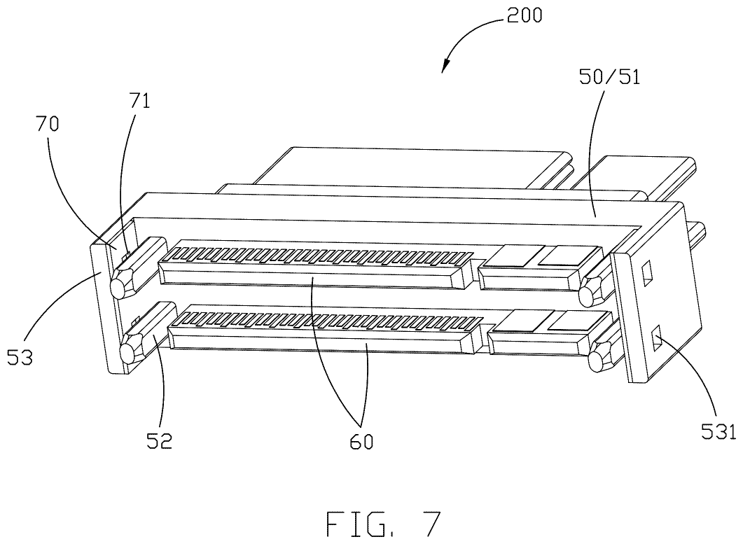

Referring to FIGS. 7-9, The plug connector 200 includes an insulating housing 50 having a base portion 51, and two paddle cards 60 going across the base portion 51 and arranged in the first direction, each of the two paddle cards 60 extending in a second direction perpendicular to the firs direction. A pair of guiding posts 52 extends from the base portion 51 and located at opposite ends of the paddle card 60 in the second direction. A pair of guiding boards 53 extends forwards from the base portion 51 beyond the guiding posts 52 in the first direction. The guiding posts 52 extend forwards beyond the paddle cards 60 in the mating direction.

Each of the paddle cards 60 includes a signal part 61 loaded with signal pads 612 and a second part 63 loaded with power pads 632. A metallic plate 70 is attached at an inner side of each guiding board 53, the metallic plates 70 directly face corresponding guiding posts 52, respectively. The metallic plate 70 has two locking holes 71 which are aligned with corresponding guiding posts 52. The guiding board 53 can also have locking holes 531 communicating with the locking holes 71 of the metallic plate 70. The guiding board 52 is flush with the base portion 51 in the first direction. Each paddle card 60 and corresponding guiding posts 52 and corresponding locking holes 531, 71 are aligned with each other in the first direction. It is noted that each paddle card 60 and corresponding guiding posts 52 and corresponding locking holes 71 are separated from each other in the first direction. The guiding posts 52 protrude forwards beyond the guiding board 53 and the paddle cards for a preliminary position during an engagement of the two connectors. The guiding posts 52 are guided and inserted into the guiding holes 12 and the metallic plates 70 contact two opposite outer ends of the metallic shell 40, the spring fingers 31 are engaged with the locking holes 71 for a further retaining engagement of the two connectors.

Although the present invention has been described with reference to particular embodiments, it is not to be construed as being limited thereto. Various alterations and modifications can be made to the embodiments without in any way departing from the scope or spirit of the present invention as defined in the appended claims.

1. A receptacle electrical connector comprising:
an insulating housing having two mating slots arranged in a first direction and each of the two mating slots extending in a second direction perpendicular to the first direction;
two rows of terminals located at opposite sides of each of the two mating slots; and
a metallic shell surrounding around an outer side of the insulating housing;
wherein the insulating housing has two opposite guiding holes at opposite ends of each of the two mating slots in the second direction, and each of the guiding holes is defined by the metallic shell at an outer side perpendicular to the second direction.

2. The receptacle electrical connector as claimed in claim 1, wherein each of the two mating slots has a first area and a second area arranged in the second direction, the two rows of terminals comprises two rows of signal terminals and two rows of power terminals, the two rows of signal terminals are located at opposite sides of the first area, and the two rows of power terminals are located at opposite sides of the second area.

3. The receptacle electrical connector as claimed in claim 2, wherein the first area is deeper than the second area:

4. The receptacle electrical connector as claimed in claim 2, further comprising plural cables, wherein the plural cables are connected with corresponding rows of signal terminals and corresponding rows of power terminals.

5. The receptacle electrical connector as claimed in claim 2, wherein the row of the signal terminal is embedded in an insulator, and a conductive plastic is attached at an outer side of the insulator to form a terminal module, and a metallic grounder is located between the two rows of the signal terminals.

6. The receptacle electrical connector as claimed in claim 2, wherein each of the two mating slots is continuous without any partitioning wall.

7. The receptacle electrical connector as claimed in claim 2, wherein each row of the two rows of signal terminals is composed of thirty-seven terminals, and each row of the two rows of power terminals is composed of two terminals.

8. The receptacle electrical connector as claimed in claim 1, wherein the metallic shell has four spring finger extending outward in the second direction, each of the four spring finger is aligned with corresponding guiding hole.

9. A plug electrical connector comprising:
an insulating housing having a base portion;
two paddle cards going across the base portion and arranged in a first direction, each of the two paddle cards extending in a second direction perpendicular to the firs direction; and
a pair of guiding posts extending forwards from the base portion and located at opposite ends of each of the two paddle cards;
wherein a pair of guiding boards extend forwards from the base portion, and the guiding boards extend beyond the guiding posts in the first direction and are separated from two adjacent guiding posts in the second direction.

10. The plug electrical connector as claimed in claim 9, wherein each of the two paddle cards comprises a signal part loaded with signal pads and a second part loaded with power pads.

11. The plug electrical connector as claimed in claim 9, wherein a metallic plate is attached at an inner side of each of the pair of guiding boards, the metallic plates directly face corresponding guiding posts.

12. The plug electrical connector as claimed in claim 11, wherein each of the pair of metallic plates has two locking holes, each of the two paddle cards and corresponding guiding posts and corresponding locking holes are aligned with each other in the second direction.

13. The plug electrical connector as claimed in claim 12, wherein the guiding board has four locking holes which are aligned with corresponding locking holes of the metallic plates in the first direction.

14. An electrical connector assembly comprising:
an insulating housing having two mating slots arranged in a first direction and each extending in a second direction perpendicular to the first direction, each of the two mating slot having a first area and a second area arranged in the second direction;
two rows of signal terminals located at opposite sides of each of the first areas; and
two rows of power terminals located at opposite sides of each of the second areas;
wherein four flat cables are connecting with corresponding rows of signal terminals and power terminals, respectively.

15. The electrical connector assembly as claimed in claim 14, further comprising a metallic shell surrounding around an outer side of the insulating housing.

16. The electrical connector assembly as claimed in claim 14, wherein each of the two mating slots is continuous without any partitioning wall.

17. The electrical connector assembly as claimed in claim 16, wherein each row of signal terminals is composed of thirty seven terminals, each row of power terminals is composed of two terminals.
